(19) United States
(12) Patent Application Publication
(10) Pub. No.: US 2010/0228531 A1
(43) Pub. Date: Sep. 9, 2010

(54) ZINC OXIDE (ZNO) VARISTORS DEGRADATION ANALYSIS SYSTEM USING PARAMETERS FROM THE MODIFIED LONGEVIN MODEL

(75) Inventors: Nelson Jhoe Batistela, Florianopolis (BR); James Silveira, Florianopolis (BR); Patrick Kuo-Peng, Florianopolis (BR); Nelson Sadowiski, Florianopolis (BR); João, Pedro, Assumpção Bastos, Florianopolis (BR); Renato Carlson, Florianopolis (BR)

Correspondence Address: Kathleen A. Costigan;HEDMAN & COSTIGAN, P.C., 1185 Avenue of the Americas, New York, NY, US

(73) Assignee: UNIVERSIDADE FEDERAL DE SANTA CATARINA, Florianópolis SC (BR)

(21) Appl. No.: 12/670,404

(22) PCT Filed: Jul. 22, 2008
(86) PCT No.: PCT/BR08/00214

§ 371 Date: Jan. 24, 2010

(30) Foreign Application Priority Data
Jul. 25, 2007 (BR) PI 0701878-9

(51) Int. Cl. G06F 17/10

(52) U.S. Cl. 703/2

(57) ABSTRACT

It is a method to appraise the life of a lightning rod using the “Modified Longevin Function” initially applied to represent the field and induction magnetic magnitudes in ferromagnetic materials modified properly to the inherent magnitudes of the characteristic curve of the lightning rods' varistors, current and voltage, measuring the variation of the parameters from the lightning rod model, using the adapted “Modified Langevin Function” through out the lightning rod life evaluating the lightning rod functional status based on the variation of the three parameters of the lightning rod varistor developed model; also using a lightning rod leakage current measurement system with techniques to get the share of the resistive current flowing through the varistor and with techniques to determine the parameters from the model that uses a software to meet the varistor model parameters.

### FIELD OF THE INVENTION

The system hereby described consists in associating the representation of the ZnO (Zinc Oxide) varistors used in the high tension lightning rods by means of the Longevin modified model with the analysis to evaluate the life of said device. The system allows studying the variation of the model's parameters while the ZnO lightning rod is being used. Than, the variation of the parameters can be used as of a tool in the conclusive reasoning on evaluating the varistors degradation process, i.e., the lightning rods.

### BACKGROUND OF THE INVENTION

The lightning rods most used monitoring techniques are the thermo-vision and measuring the leakage current ones. Up to now, thermo-vision still is the one most used by enterprises dealing in the electrical field. This is due to a lot of factors such as being the most reliable one because of the accumulated experience, the large number of operating SiC lightning rods (in which measuring the leakage current is not used because they have an “airgap”) and the high cost of the measuring instruments to get a diagnosis through the leakage current. Gradually substituting the older SiC lightning rods by the ZnO new ones and considering the fact that thermo-vision is a technique that only ascertains an already existent problem, efforts have been directed to studies on the relationship between the lightning rods leakage current and its degradation. This is a modern-day worry. Some years ago one did not care so much about lightning rods in high tension systems. Presently, due to new legal and commerce requirements this protective device has become one of the periodically checked items by the maintenance teams. When a ZnO lightning rod fails besides the possibility of having people killed it turns the system, which it is connect to, out of order bringing financial losses to the electrical energy concessionaire. There may also be social and economical consequences generally of a high amount of money besides the possibility of damaging other equipments after it explodes. As the ZnO lightning rods don't have said “airgap” they are more suited to an explosion on account of the thermal instability that can be reached with the varistor's degradation.

The presence of harmonics in the shape of a tension wave where the lightning rod is placed may lead to inaccuracies when analyzing the conditions of the ZnO blocks forming the varistor. The references from H. Zhu, M. R. Raghuveer, “Influence of Harmonics in System Voltage on Metal Oxide Surge Arrester Diagnostics”. Conference on Electrical Insulation and Dielectric Phenomena, 1999 and J. Silveira, N. J. Batistela, P. Kuo-Peng, N. Sadowski, “Modelagem de Varistor de Óxido de Zinco Utilizando a Função de Langevin Modificada—Zinc Oxide Varistor Modeling Using the Modified Longevin Function”, XII Eriac, Foz do Iguaçu—PR, Brazil, May 2007 show the inaccuracy a harmonic content in the shape of a tension wave may create leading to lightning rods wrong appraisals. Among the techniques using the direct measuring of the leakage current to appraise the degradation the one considered the most reliable by the users is the one using the resistive component third harmonics linked to the harmonics compensation in the form of an electrical tension wave of the system. This technique is used worldwide by enterprises with the aid of an instrument called LCM II from the firm Transinor, considering the characteristics given by the manufacturer and the historical data collected for each lightning rod group. Another enterprises commercialize instruments to evaluate the leakage current from lightning rods which are not so well accepted by the users such as the DIAG from Tridelta and the Excount II from ABB.

One justifies the gradual substitution of the older SiC lightning rods by the ZnO ones and the fact that thermo-vision is a new technique that only records an already existent problem and also motivates the development of studies and advanced techniques in order to better understand the relationship between the lightning rods leakage current and its degradation, as well as using new knowledge assuring a more reliable procedure on appraising high tension lightning rods.

The ZnO lightning rods allow the flow of a leakage current due to its internal and external characteristics. Such a current has a resistive component with non-linear characteristics going mainly through out the varistor. The intensity of the resistive component is related to energetic losses and shows the degradation grade of the ZnO blocks. According to IEC 99-5, it represents something between 5 and 20% of the total leakage current which also has a capacitive component. The capacitive component is prevalent (between 80 and 95% of the total leakage current) when the ZnO blocks are not degraded and has a linear characteristic. That is, the leakage current capacitive component is a direct function of the voltage applied to the lightning rod and also has the same shape of a tension wave.

The simplified equivalent circuit generally used to state this analysis of separating the components was presented by “LUNDQUIST, J.; STENSTROM, L.; SCHEL, A.; HANSEN, B., “New Method for Measurement of the Resistive Leakage Current of Metal Oxide Surge Arresters in Service”, IEEE Transactions on Power Delivery, Vol. 5, No. 4, November 1990”. It comprises a non-linear resistor (Rₚ) representing the ZnO blocks and a capacitor (Cₚ) representing the parallel capacitances of the lightning rod. The voltage typical characteristic in terms of the current to the ZnO lightning rods is presented by SCHEI, A., “Diagnostic Techniques for Surge Arresters with Main Reference to On-line Measurement of Resistive Leakage Current of Metal Oxide Arresters”, PI-05, Section 2000, CIGRÉ. According to this reference and through practical knowledge from the appraisers of the lightning rod functional status, the temperature is a factor that interferes in the leakage current value.

Concerning the leakage current the main parameters measured in view of the diagnosis are the total current comprising its medium value and the peak one, the total current resistive component, the total current capacitive component, the harmonic distortion and the losses' power. Among the methods used to measure the leakage current in a lightning rod, one finds:

### Total Current Measurement

The method that uses the total leakage current measurement is usually performed by installing a milliammeter at the discharge meter or using portable instruments. The readings may show the effective value, the peak value or the medium value of the leakage current rectified wave shape as described by SCHEL, A. above mentioned.

Generally, the total leakage current resistive component has amplitude shorter than the capacitive component. When the total leakage current has a capacitive component of 750 μA, the resistive component of an operational varistor according to the technical specifications may vary between 50 μA and 250 μA. So, even enlarging the amplitude of the resistive component the total leakage current varies too little between a lightning rod in good working shape and an already degraded one. On the other hand, small changes of the capacitive component may be so meaningful in the total leakage current amplitude that they may conceal an evaluation of the lightning rod. The analysis of the degradation of ZnO blocks forming the varistor is linked to the total leakage current resistive component.

### Direct Measurement of the Leakage Current Resistive Component

Presently, the direct finding of the resistive component is the most effective way used for monitoring in using the leakage current as a means of analysis of the lightning rod conditions, since it is possible to immediately compare it with a suitable reference value. According to the above bibliographic references, it is a method requiring the simultaneous measurement of the current and voltage at the lightning rod. This measurement makes it possible to compare the signals at a certain moment and finding the resistive component value. This instrument works this way: when the voltage reaches the maximum value the capacitive component is null and the system's voltage wave shape may be get by means of an electrical field sensor, as the one used by the LCM from Transinor. At this point the value of the total leakage current corresponds to the maximum amplitude of the resistive component.

### Leakage Current Harmonic Analysis

The leakage current resistive component has a harmonic content due to the non-linear characteristic of the lightning rod's ZnO blocks as previously mentioned and described by PEITEADO, M.; DE LA RUBIA, M. A.; VELASCO, M. J. et al. “Bi₂O₃ Vaporization from ZnO-based Varistors”, J. Eur. Ceram. Soc. En prensa (available online). This makes the total leakage current present, when the lightning rod is being used, a certain harmonic distortion degree. The analysis of this harmonic distortion gives way to a lot of methods to evaluate the operational conditions of the ZnO variators, such as the total adding of the leakage current harmonics, the exclusive analysis of the leakage current third order harmonic and the analysis of the resistive leakage current's third order harmonic component with compensation of the harmonics imposed by the wave shape of the electrical network voltage.

### Appraisal Through Varistor Models

Technical literature does not present any model which parameters, or their variation, can be used to evaluate the lightning rods degradation degree. The inventive step is using the suggested evaluating tool: a model of varistor for lightning rod has been developed based on the “Modified Langevin Function” having three parameters. When the varistor is degraded, the parameters vary in such a way that the parametrical variation degree establishes the lightning rod life condition.

### BRIEF DESCRIPTION OF THE DRAWINGS

FIG. 1 shows the curves representing the varistor behavior while new (curve a) and degraded (curve b).

FIG. 2 shows the interface of the developed instrument; a prototype to determine the varistor model parameters based on the modified Langevin equation. The results refer to the new varistor.

FIG. 3 shows the interface of the developed instrument; a prototype to determine the varistor model parameters based on the modified Langevin equation. The results refer to the degraded varistor.

FIG. 4 shows a block diagram of the developed and suggested system for evaluating the life condition of high tension lightning rod varistors.

### DESCRIPTION OF THE INVENTION

The accuracy and effective performance of the lightning rods models are associated, among certain factors, mainly to the representation of the varistors used therein. Modeling the varistor itself is already a problem due to its non-linear characteristic and to the great number of degradation factors.

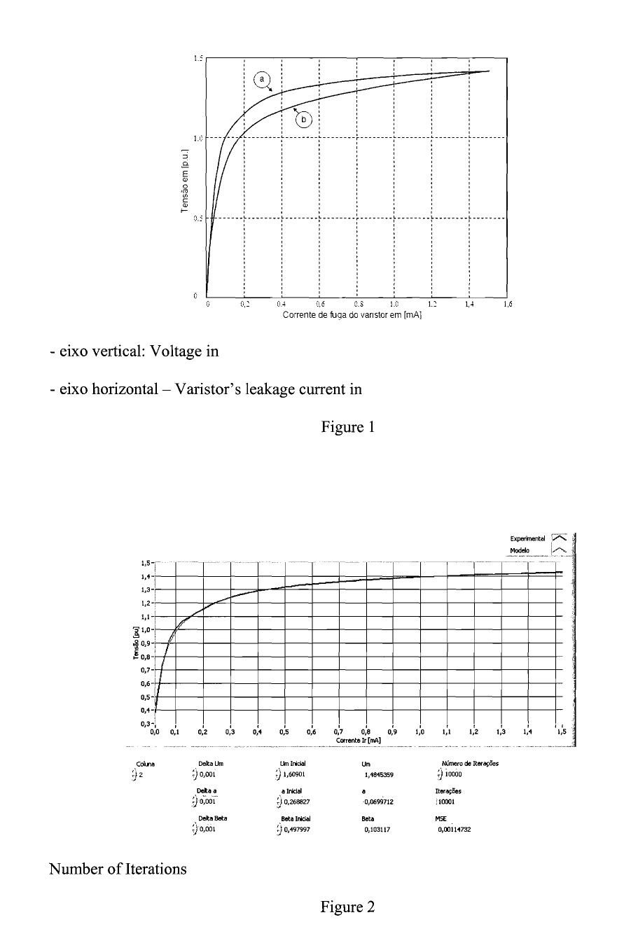

FIG. 1 shows the curves representing the varistor behavior while new (curve a) and degraded (curve b) got from the worldwide referred to work of Hanxim and Raghuveer, (ZHU, H. and RAGHUVEER, M. R. in “Influence of Harmonics in System Voltage on Metal Oxide Surge Arrester Diagnostics”, Conference on Electrical Insulation and Dielectric Phenomena, 1999) and from Bargigia (BARGIGIA, A.; GIANNUZZI, L.; INEZI, A. et al. in “Study of the Performance of Metal Oxide Arresters for High Voltage Systems”, International Conference on Large High Voltage Electric Systems, 27^{th} Aug.—4^{th} 4 Sep. 1986). This figure is a reproduction of the curves presented by Hanxim and Raghuveer for the lightning rod varistor resistive leakage current in terms of the applied voltage.

The developed model is based on the Langevin function applied for modeling ferromagnetic materials with a modification suggested by Weiss (CULLITTY, B. D. Introduction to Magnetic Materials. USA: Addison-Wesley Publishing Company, 1972) to be applied to ferromagnetic materials representing the magnetic induction and magnetic field relationship. This same function used to the magnetic magnitude, field and induction, has been adapted, respectively, to the magnitudes inherent to the varistors' characteristic curve, which are the leakage resistive current and the voltage applied to the lightning rod. With the development of a new and original ZnO lightning rod varistor model, represented by equation (1), the behavior of the current at the varistor depends on three parameters: Uₘ, α and β. In equation (1) the variables u(t) and iᵣ(t) correspond respectively to the voltage applied to the varistor and to the resistive current flowing therein.

$$u ( t ) = {U}_{m} [ coth ( \frac{{i}_{r} ( t ) + β u ( t )}{a} ) - ( \frac{a}{{i}_{r} ( t ) + β u ( t )} ) ] \qquad ( 1 )$$

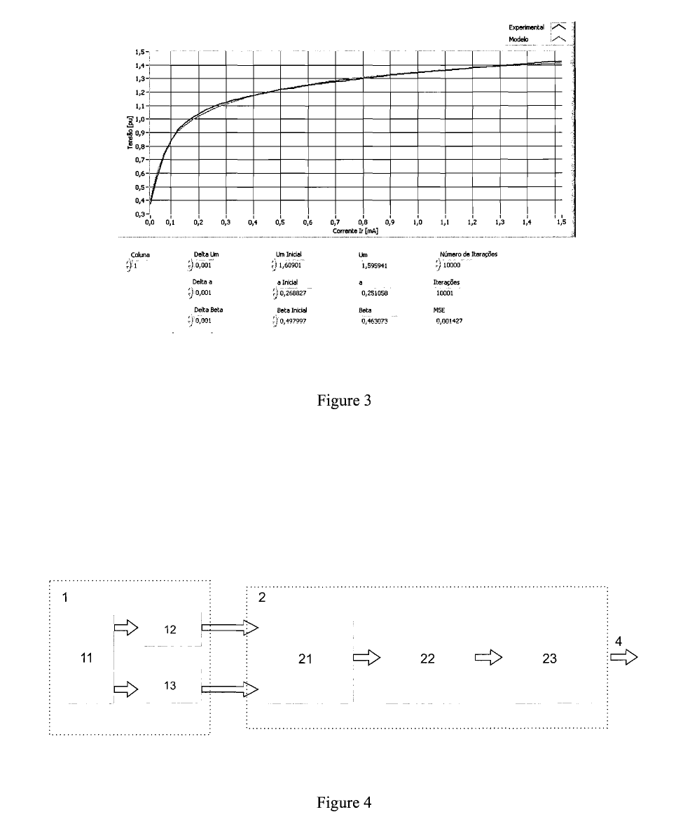

FIGS. 2 and 3 correspond to the representation of the varistor's curves presented in FIG. 1. FIG. 2 shows the interface of the developed prototype system determining the parameters of model (1) related to the new varistor. FIG. 3 shows the interface of the developed prototype system determining the parameters of model (1) related to the degraded varistor. One can see that the parameters of the proposed model had a significant variation from a new varistor with its degradation. The parameter Uₘ varied in 7.5%, the parameter a in 258.8% and the parameter β in 349.1%.

The present patent application refers to using this model to evaluate the lightning rods based on the variation of its three parameters using a lightning rod leakage current measuring system with techniques (software) to get the share of the resistive current flowing through out the varistor, using techniques for determining the parameters of the model by means of a software meeting the model's parameters. The softwares are in a hardware system like the commercial ones.

FIG. 4 represents the system to evaluate the degree of degradation of the high tension lightning rod varistors by means of the parametrical variation of the developed model. In block (1) representing the lightning rod (11) and the measuring process are the voltage gauge (12) to measure the voltage applied to the lightning rod and the lightning rod leakage current gauge (13). In block (2) representing the computerized system to appraise the data got from the measurements are the equipments to determine the lightning rod varistor characteristic curve (21) and the system to determine the parameters or characteristic curves (22) of the model applied to the lightning rod varistor. Once having the model's characteristic curves from the varistor (21) and from the parameters (22), one makes the appraisal (23) of the variation of the model's parameters applied to the lightning rod's varistor. The result (4) of the appraisal determines the varistors' degree of degradation.

1. ZINC OXIDE (ZnO) VARISTORS DEGRADATION ANALYSIS SYSTEM USING PARAMETERS FROM THE MODIFIED LONGEVIN MODEL is a method to appraise the life of a high tension zinc oxide lightning rod characterized by using the modeling by means of the “Modified Longevin Function”; by adapting the model to the magnitudes inherent to the curve characteristic of the lightning rods varistors in terms of the current and the voltage; by using techniques to determine the parameters of the model and by evaluating the life and the degradation degree of lightning rods using the variation of the model's parameters.

2. ZINC OXIDE (ZnO) VARISTORS DEGRADATION ANALYSIS SYSTEM USING PARAMETERS FROM THE MODIFIED LONGEVIN MODEL according to claim 1, characterized by appraising the lightning rod based on the variation of the three parameters of the lightning rod model, and being said three parameters determined using a lightning rod leakage current measuring system with measuring system techniques and data treatment software to get the share of the resistive current that flows through the varistor.

3. ZINC OXIDE (ZnO) VARISTORS DEGRADATION ANALYSIS SYSTEM USING PARAMETERS FROM THE MODIFIED LONGEVIN MODEL is a appraising process characterized by comprising the steps of:
a) Measuring the applied voltage and the leakage current related to the new varistor, determining its characteristic curve;
b) Measuring the applied voltage and the leakage current related to the varistor being used, determining its characteristic curve;
c) Appraising the evolution of the varistors' degradation degree based on the data from the measurements and on the varistors' characteristic curves from the new ones (initial project characteristics) up to the last done measurement, comparing the curves from the new lightning rod model related to the lightning rod being used;
d) Appraising the evolution of the varistors' degradation degree based on the data from the measurements and on the varistors' characteristic curves from the new ones (initial project characteristics) up to the last done measurement, comparing the model's parameters for the new lightning rod related to the ones for the lightning rod being used;
e) Providing a varistor degradation diagnosis under analysis.
